(19) United States
(12) Patent Application Publication
(10) Pub. No.: US 2008/0233263 A1
(43) Pub. Date: Sep. 25, 2008

(54) Beverage

(76) Inventor: Johannes COY, Otzberg (DE)

Correspondence Address: JOYCE VON NATZMER;PEQUIGNOT + MYERS LLC, 200 Madison Avenue, Suite 1901, New York, NY, 10016, US

(21) Appl. No.: 12/052,173

(22) Filed: Mar. 20, 2008

Related U.S. Application Data
(60) Provisional application No. 60/896,309, filed on Mar. 22, 2007.

(30) Foreign Application Priority Data
Mar. 20, 2007 (DE) 10 2007 013 903

(51) Int. Cl. A23L 2/38; C12G 3/00

(52) U.S. Cl. 426/592; 426/590

(57) ABSTRACT

The present invention provides a beverage, comprising: 5-35% weight/volume fat and/or oil, wherein the fat/oil comprises vegetable oils, and comprises a maximum of 30% weight/volume saturated fatty acids and minimum 20% weight/volume unsaturated fatty acids, said unsaturated fatty acids comprising omega-3-fatty acids and omega-6-fatty acids, and the weight ratio of said omega-6 fatty acids to said omega-3 fatty acids is no greater than 4:1; a maximum of 2.5% weight/volume of carbohydrates; and lactic acid; wherein the content of fat and/or oil is higher than the carbohydrate content by weight. The beverage is especially suitable for patients suffering from inflammatory diseases (Ulcerative Colitis, Rheuma, Multiple Sclerosis), from diabetes and associated chronic diabetes complications (retinopahty, neuropathy, nephropathy, micro- and macrovascular damages e.g. blood vessel damages, myocardial infarction), from neurodegenerative diseases (Alzheimer's, Wernicke-Korsakoff syndrome), and from cancer.

### CROSS-REFERENCE TO RELATED APPLICATIONS

This application claims the benefit of U.S. provisional application 60/896,309, filed Mar. 20, 2008, which is incorporated herein by reference in its entirety. This application also claims foreign priority from German patent application DE 10 2007 013 903, filed Mar. 20, 2007, which is also incorporated herein by reference in its entirety.

### FIELD OF THE INVENTION

The invention relates to a beverage with a relative high fat and/or oil content and a relative low carbohydrate content.

### BACKGROUND OF THE INVENTION

Glucose plays a very important role in a wide variety of metabolic processes for humans. Many human cells utilize this sugar as a source of energy. However, because of the chemical properties of glucose, an oversupply of glucose can lead to serious cell damage and thus to serious illnesses. Glucose has the disadvantage that a portion of the molecule is in a reactive form (the open aldehyde form). As is the case with formaldehyde, this reactive form of glucose under goes irreversible reactions with proteins, resulting in damage to the proteins. Thus, an excessive concentration of glucose in the cell leads to severe damage in the long term. Many cells and tissues of the human body are especially affected by excessively high glucose concentrations. These are precisely the tissues that are damaged in diabetics due to high glucose levels: the retina, nerve cells (neurons) and blood vessel cells (endothelial cells). Over a long period of time, chronic diabetic long-term damage occurs, such as retinopathy, neuropathy and blood vessel damage, ultimately leading to blindness, nerve damage and myocardial infarction.

Recent studies have shown that certain forms of cancer cells need glucose as fuel. These forms of cancer cells are extremely aggressive and utilize the TKTL1 enzyme to obtain energy from glucose even if no oxygen is available. These cancer cells do not use glucose like healthy cells (by breaking them down to H₂O, CO₂, and ATP). Instead, they ferment the glucose to lactic acid (lactate), both in the presence and absence of oxygen. Glucose thus makes a significant contribution toward the progression of aggressive cancers. Although such cancer cells are extremely aggressive and can develop metastases, these cancer cells have an Achilles heel. They depend on glucose. In many cases, these cancer cells cannot switch to burning fat because the mitochondria have been deactivated or have even become incapable of functioning. These cancer cells are thus absolutely dependent on glucose as their sole source of fuel. Cancerous tumors having locally limited growth occur throughout the animal kingdom. However, it is interesting that cancer in its most aggressive form, i.e., metastatic cancer, occurs as one of the main causes of death mainly only in humans with a Western lifestyle and in some of the domestic animals fed by such persons. Cancer is not a significant problem in any other creatures. Death due to cancer is limited essentially to a few creatures: humans with a Western lifestyle, the dog, the domestic cat and animals kept in a laboratory and fed by humans, e.g., laboratory mice and rats. In other words, these are the only creatures that consume large amounts of carbohydrates, which release a large amount of glucose rapidly during digestion.

If too much glucose is released too rapidly in the digestion of foods over the long term, this makes a significant contribution toward the development of diseases. Glucose here leads to cell damage through “advanced glycation end products” (AGE) and radicals. This makes a significant contribution toward long-term diabetic damage (retinopathy, neuropathy, nephropathy and micro- and macrovascular damage). This triggers diseases such as neurodegenerative diseases (e.g., Alzheimer's, Wernicke-Korsakoff syndrome, dementia), endothelial cell damage and vascular damage (myocardial infarction, stroke) as well as inflammatory diseases (multiple sclerosis, Crohn's disease, ulcerative colitis, rheumatoid arthritis).

A strategy for preventing such diseases as those mentioned above which are triggered by excessively high glucose concentrations, consists of production of liquid foods which release only a small amount of glucose and release it slowly during digestion. Since glucose is also a fuel for fermenting cancer cells, liquid foods which release only a small amount of glucose and release it slowly during digestion can improve the survival chances of a person who has cancer. By adding lactic acid, the end product of fermentation, an inhibiting effect on the fermentation metabolism in cancer cells can be achieved. The foodstuff in liquid form described below can be used for nutrition for humans or mammals as an exclusive food or in combination with other foods that release only a small amount of glucose and release it slowly. This diet may be used as a preventive measure, as a measure to support therapy or as the sole therapy.

It is therefore a need in the art for such a foodstuff.

### BRIEF SUMMARY OF THE INVENTION

In one aspect, the present invention provides a beverage, comprising: 5-35% weight/volume fat and/or oil, wherein the fat/oil comprises vegetable oils, and comprises a maximum of 30% (weight/volume) saturated fatty acids and minimum 20% (weight/volume) unsaturated fatty acids, said unsaturated fatty acids comprising omega-3-fatty acids and omega-6-fatty acids, and the weight ratio of said omega-6 fatty acids to said omega-3 fatty acids is no greater than 4:1, or not greater than 2:1; a maximum of 2.5% weight/volume, a maximum of 2.3% weight/volume, a maximum of 1.8% weight volume, a maximum of 1.7% weight/volume or a maximum of 1.6% weight/volume of carbohydrates; and lactic acid; wherein the content of fat and/or oil is higher than the carbohydrate content (by weight).

### VARIOUS AND PREFERRED EMBODIMENTS OF THE INVENTION

The described beverage may provide one or more of the following advantages.

Due to the ratio of higher fat/oil content versus lower carbohydrate content—preferably the fat/oil content is at least twice or twice the carbohydrate content—the beverage provides an energy supply while being low in carbohydrates.

Due to its relatively high content of essential fatty acids the beverage provides a considerable source of biosynthetic components which are essential but cannot be produced by the body itself.

The required ratio of omega-6-fatty acids to omega-3-fatty acids may reduce the negative effects associated with excess omega-6-fatty acids. Excessive levels of omega-6-fatty acids to omega-3-fatty acids, increase the possibility of a number of diseases such as inflammatory diseases. In certain embodiments, processes associated with these diseases may even be inhibited.

Therefore the beverage is especially suitable for consumers or patients suffering from inflammatory diseases (Ulcerative Colitis, Rheuma, Multiple Sclerosis), from diabetes and associated chronic diabetes complications (retinopahty, neuropathy, nephropathy, micro- and macrovascular damages e.g. blood vessel damages, myocardial infarction), from neurodegenerative diseases (Alzheimer's, Wernicke-Korsakoff syndrome), and from cancer.

The content of lactic acid in the beverage effects an inhibition of the fermentation metabolism from glucose to lactate (referred to biochemically as end product inhibition). Furthermore the lactic acid cannot be used in the TKTL1-metabolism pathway for energy production because lactic acid is not a suitable substrate for that metabolism. Therefore that beverage is especially suitable for patients who suffer from a type of cancer associated with an activated TKTL1-glucose metabolism.

The content of lactic acid in the beverage provides the additional advantage that lactic acid positively effects the flora of the intestine of the consumer, inter alia by promoting deacidification by generating bases and by providing an energy source for epithelia of the intestine, heart, liver and kidney.

The content of lactic acid should be preferably at least to 0.3% weight/volume. More preferably 1 to 2% weight/volume, and especially preferably 1.4% weight/volume. These amounts ensure on the one hand, that the positive properties of lactic acid are apparent and on the other hand that the taste of the beverage is not affected.

The lactic acid may be present in both the L and D forms (levorotatory L-(+)-lactic acid and dextrorotatory D-(−)-lactic acid), so that the formation of L-lactic acid via the Embden-Meyerhof pathway and the pentose phosphate pathway and the formation of D-lactic acid via the methylglyoxal pathway are inhibited. A higher levorotatory L-(+)-lactic acid content is preferable up to an approximately equal volume ratio of D- and L-lactic acid to one another.

The fat/oil content in the beverage preferably consists solely or consists essentially of vegetable fats and/or oils or of a mixture of vegetable and animal fats and/or oils. In any case the vegetable oils should be rich in unsaturated fatty acids, because unsaturated fatty acids are essential, and because the ratio of omega-3 fatty acids to omega-6 fatty acids is a determining factor in whether a cell or an organism remains healthy or falls ill.

In addition to use for cancer, the inventive beverage in all the variants mentioned above is also suitable for reducing or even preventing the cell damage associated with high glucose concentrations, which contributes significantly toward neurodegenerative diseases, long-term diabetic damage and micro- and macrovascular damage, for example.

The carbohydrate content of the beverage is a maximum of 2.5% weight/volume. The carbohydrate content may also be a maximum of 2.3%, 1.8%, 1.7%, or 1.6% weight/volume. The carbohydrate content may be for example 2.3%, 1.8%, 1.7%, or 1.6% weight/volume.

The beverage may be either alcoholic or nonalcoholic.

An isotonic variant of the beverage described herein is suitable for athletes, in particular.

This beverage may also contain protein or free amino acids. In the present context the term ‘free amino acid’ refers to amino acids which are available not in peptide form (i.e. di-, tri-, oligo-, polypeptide) but monomers. The protein or amino acid content may be in a range of 0.1% to 25% (weight/volume, weight/weight), preferably in a range of 1% to 8% (weight/volume, weight/weight) and most preferably in a range of 1.5% to 2.5% (weight/volume, weight/weight). The added proteins are preferably those which contain a large percentage amount of ketogenic amino acids (such as 20% to 40%, 41 to 80% or 81% to 100%) and a small percentage amount of glucogenic (glucoplastic) amino acids which release glucose precursors such as pyruvate, β-ketoglutarate, succinyl-CoA, fumarate or oxalacetate in degradation of their carbon structure.

The ketogenic amino acids are preferably threonine, phenylalanine, tyrosine, tryptophan, isoleucine, lysine and leucine, most preferably the amino acids lysine and/or leucine.

In addition, free amino acids may also be added to the beverage. To this end, the ketogenic amino acids threonine, phenylalanine, tyrosine, tryptophan, isoleucine, lysine and leucine in particular are proposed, the amino acids lysine and leucine being especially preferred.

With the supplement of free amino acids the portion of ketogenic amino acids can be selectively increased and thereby the gluconeogenesis (i.e. the synthesis of glucose from amino acids within the liver) can be reduced.

The pH value of the beverage should preferably be equal or less to pH 4.5. This is associated with the advantage that stability and storage life of the beverage are increased and that it has a slight sour taste which the consumers find refreshing.

The beverage according to the invention will be explained more in detail with the following examples.

### EXAMPLES

### Example 1

### Beverage—alternative 1

(General Ingredients: Yogurt cell culture, milk, thickening agent, vegetable oil 1 (e.g. rapeseed oil), vegetable oil 2 (e.g. grapeseed oil or hempseed oil or linseed oil), water)
Ingredients (amounts given in % weight/volume):

Less than 0.01% Yogurt cell culture, about 50% milk, about 0.8% thickening agent (e.g. pectin), about 3% vegetable oil 1 (e.g. rapeseed oil), about 1% vegetable oil 2 (e.g. grapeseed oil or hempseed oil or linseed oil), about 45% water;

### Preparation:

The ingredients were admixed and then subjected to fermentation. The pH was adjusted at the end of the fermentation process. The beverage was then bottled.

The final product has the following average nutrient content per 100 ml beverage: about 2 g protein, about 1.6 g carbohydrates, about 0.4 g L-lactate, about 0.25 g D-lactate and about 5.3 g fat, wherein said fat comprising about 1.3 g saturated fatty acids and about 4 g unsaturated fatty acids and wherein said unsaturated fatty acids comprising about 0.3 g omega-3-fatty acids and about 1.2 g omega-6-fatty acids.

### Example 2

### Beverage—alternative 2

(General Ingredients: Jogurt cell culture, soya base, thickening agent, sugar, vegetable oil 1 (e.g. rapeseed oil or walnut oil), vegetable oil 2 (e.g. grapeseed oil or hempseed oil or linseed oil), water)
Ingredients (amounts given in % weight/volume):

Less than 0.02% Yogurt cell culture, about 55% soya base (9%), about 0.8% thickening agent, about 1.6% sugar, about 3.3% vegetable oil 1 (e.g. rapeseed oil or walnut oil), about 1.2% vegetable oil 2 (e.g. grapeseed oil or hempseed oil or linseed oil), about 38% water;

### Preparation:

The ingredients were admixed and then subjected to fermentation. The pH was adjusted at the end of the fermentation process. The beverage was then bottled.

The final product has the following average nutrient content per 100 ml beverage: about 1.8 g protein, about 1.6 g carbohydrates, about 0.6 g L-lactate, about 0.1 g D-lactate and about 5.2 g fat, wherein said fat comprises about 0.6 g saturated fatty acids and about 4.6 g unsaturated fatty acids and wherein said unsaturated fatty acids comprise about 0.5 g omega-3-fatty acids and about 1.3 g omega-6-fatty acids.

### Example 3

### Beverage—alternative 3

(General Ingredients: Soya base, thickening agent, vegetable oil 1 (e.g. rapeseed oil or hempseed oil), vegetable oil 2 (e.g. grapeseed oil or linseed oil), water, lactic acid)
Ingredients (amounts given in % weight/volume):

About 56% Soya base (9%), about 0.8% thickening agent, about 3.3% vegetable oil 1 (e.g. rapeseed oil or hempseed oil), about 1.2% vegetable oil 2 (e.g. grapeseed oil or linseed oil), about 38% water, about 0.6% lactic acid.

### Preparation:

The ingredients were admixed, and the pH was adjusted. The beverage was then bottled.

Different to the beverage according to alternative 1 and 2 in the course of preparation this beverage-alternative 3 is fermented during preparation but contains lactic acid in form of an additional ingredient (additive).

### Example 4

### Beverage—alternative 4

### Ingredients:

Skim milk yogurt, water, vegetable oil (such as grapeseed, linseed, rapeseed, and/or hempseed oils), cream, and thickening agent (i.e. pectin).

These ingredients were mixed in proportions such that the final product had the following average nutrient content per 100 ml beverage(62 kcal (256 kJ)) of: about 1.9 g protein; about 2.3 g carbohydrates, said carbohydrates comprising about 2.1 g sugar; about 5.0 g fat, wherein said fat comprises about 1.0 g saturated fatty acids and about 2.5 g monounsaturated fatty acids, and about 1.5 g polyunsaturated fatty acids; about 0.14 g fibre; and about 23 g sodium.

### Example 5

### Beverage—alternative 5

### Ingredients:

Skim milk yogurt, water, vegetable oil (such as grapeseed, linseed, rapeseed, and/or hempseed oils), cream, and thickening agent (i.e. pectin).

These ingredients were mixed in proportions such that the final product had the following average nutrient content per 100 ml beverage(63 kcal (261 kJ)) of: about 2.0 g protein; about 1.8 g carbohydrates, said carbohydrates comprising about 1.8 g sugar; about 5.3 g fat, wherein said fat comprises about 1.3 g saturated fatty acids, about 2.5 g monounsaturated fatty acids, and about 1.5 g polyunsaturated fatty acids, of which polyunsaturated fatty acids comprise about 0.3 g omega-3-fatty acids and about 1.2 g omega-6-fatty acids; about 0.1 g fibre; and about 25 g sodium.

Although the invention has been described in detail, it is to be clearly understood that the same is by way of illustration and example, and is not to be taken by way of limitation.

What is claimed is:

1. A beverage, comprising:
a fat and/or oil content of 5-35% weight/volume,
said fat and/or oil content comprising vegetable oils and a maximum of 30% weight/volume saturated fatty acids and minimum 20% weight/volume unsaturated fatty acids, said unsaturated fatty acids comprising omega-3-fatty acids and omega-6-fatty acids, wherein the weight ratio of said omega-6 fatty acids to said omega-3 fatty acids is no greater than 4:1;
a maximum of 2.5% weight/volume of carbohydrates; and
lactic acid;
wherein the content of fat and/or oil is higher than the carbohydrate content by weight.

2. The beverage according to claim 1, wherein the weight ratio of said omega-6 fatty acids to said omega-3 fatty acids is no greater than 2:1.

3. The beverage according to claim 1 comprising a maximum of 2.3% weight/volume of carbohydrates.

4. The beverage according to claim 1 comprising a maximum of 1.8% weight/volume of carbohydrates.

5. The beverage according to claim 1 comprising a maximum of 1.7% weight/volume of carbohydrates.

6. The beverage according to claim 1 comprising at least 0.3% weight/volume lactic acid.

7. The beverage according to claim 6 having a content of lactic acid of 1% to 2% weight/volume.

8. The beverage according to claim 7, wherein the content of lactic acid is 1.4% weight/volume.

9. The beverage according to claim 1, wherein the lactic acid is in D and L forms.

10. The beverage according to claim 9, wherein a L-(+)-lactic acid is present in a higher concentration than a D-(−)-lactic acid, by molar concentration.

11. The beverage according to claim 1, wherein the fat/oil content consists of vegetable fats/oils.

12. The beverage according to claim 1, wherein the fat/oil content consists of a mixture of vegetable and animal fats/oils.

13. The beverage according to claim 1, wherein the beverage is non-alcoholic.

14. The beverage according to claim 1, wherein the beverage is alcoholic.

15. The beverage according to claim 1, wherein the beverage is isotonic.

16. The beverage according to claim 1, further comprising protein.

17. The beverage according to claim 16, wherein the protein comprises 20% to 40% by weight/volume or weight/weight of ketogenic amino acids.

18. The beverage according to claim 16, wherein the protein comprises 41% to 80% by weight/volume or weight/weight of ketogenic amino acids.

19. The beverage according to claim 16, wherein the protein comprises 81% to 100% by weight/volume or weight/weight of ketogenic amino acids.

20. The beverage according to claim 18, wherein the ketogenic amino acids being threonine, phenylalanine, tyrosine, tryptophan, isoleucine, lysine, leucine, or a mixture thereof.

21. The beverage according to claims 20, wherein the ketogenic amino acids are lysine, leucine, or a mixture thereof.

22. The beverage according to claim 1, further comprising free amino acids.

23. The beverage according to claim 22, wherein the free amino acids are ketogenic amino acids comprising threonine, phenylalanine, tyrosine, tryptophan, isoleucine, lysine, leucine, or a mixture thereof.

24. The beverage according to claim 23, wherein the free ketogenic amino acids are lysine, leucine, or a mixture thereof.

25. The beverage according to claim 1, having a pH less than or equal to pH 4.5.

26. The beverage according to claim 5 comprising at least 0.3% weight/volume lactic acid.

27. The beverage according to claim 26 having a content of lactic acid of 1% to 2% weight/volume.

28. The beverage according to claim 5, wherein the lactic acid is in D and L forms.

29. The beverage according to claim 28, wherein a L-(+)-lactic acid is present in a higher concentration than a D-(−)-lactic acid, by molar concentration.
